(19) United States
(12) Patent Application Publication
(10) Pub. No.: US 2014/0255643 A1
(43) Pub. Date: Sep. 11, 2014

(54) CUSHIONING MATERIAL

(71) Applicant: Parabeam b.v., CL Helmond (NL)

(72) Inventors: Jurgen Koot, Lanaken (BE); Jurgen Tramnitz, Hamburg (DE)

(73) Assignee: Parabeam b.v., CL Helmond (NL)

(21) Appl. No.: 14/193,993

(22) Filed: Feb. 28, 2014

(30) Foreign Application Priority Data
Mar. 11, 2013 (EP) 13 001 216.4

(51) Int. Cl. B32B 7/04; D06N 3/00

(52) U.S. Cl. CPC B32B 7/045; D06N 3/004
USPC 428/86

(57) ABSTRACT

Cushioning material for resilient, insulating or padding covering of objects or components, made of a double-pile fabric (1) being elastically impregnated by resin impregnation, in which an upper fabric (2) and a lower fabric (3) are connected in a spaced-apart manner by webs (14) that are formed by pile threads (4), wherein the elastically impregnated double-pile fabric (1) exhibits a shape resilience with a non-linear spring characteristic (5) due to the connecting webs (14), having a lower characteristic region (7), a medium characteristic region (6) and an upper characteristic region (8), the lower and the upper characteristic regions (7, 8) having an ascending profile respectively, while the medium characteristic region (6) has a less ascending hysteresis loop profile which gives the impregnated double-pile fabric (1) an internal damping capacity (W), and said internal damping capacity (W) is adjusted by the volume weight depending on the used pile threads (4) and/or the degree of hardness of the resin impregnation.

### BACKGROUND

The invention relates to a cushioning material for resilient, insulating or padding covering of objects or components.

FR 1 393 269 discloses such a cushioning material. Depending on the type of resin used, with which a woven spacer fabric is impregnated, a soft or hard material can be produced. It has been found to be disadvantageous that the cushioning material affords only weakening properties on account of external influencing variables such as temperature, noise, pressure etc.

DE 37 05 756 A1 discloses a cushion for seats in motor vehicles, said cushion consisting of a coated double woven fabric, both fabrics of which are kept at a constant spacing by pile threads and are connected to one another in an airtight manner at the peripheries. In order to climatize the seat and backrest surface and to avoid heat build-up, provision is made for the elastomeric coating on one side of the double woven fabric to be perforated in an air-permeable manner and for the interior of the cushion to be connected to a controllable air supply in order to produce a permanent airflow under positive pressure. The ventilation of a seat is improved as a result, but the sitting comfort is low since it is similar to that of an air mattress and scarcely has any damping properties.

DE 199 54 978 C1 discloses a seat part for a vehicle seat, in which an air-permeable cushion cover spans a cushion carrier made of a foam. The sitting comfort is then ensured by the foam. The foam is usually a polyurethane foam. However, polyurethane foams exhibit an altered flexibility behaviour when heated slightly by a sitting person. This heating causes the sitting person to sink in further. However, the greater sinking is associated with the person coming into contact with a large area of the plastics foam. This deeper sinking causes increased sweating.

DE 10 2004 037 625 A1 thus discloses a mattress having at least one layer made of a woven spacer fabric, wherein the woven spacer fabric consists of two outer woven fabric layers which are connected to one another by elements such as filaments, fibres or threads. This woven spacer fabric has a graduated flexibility since further and thinner woven fabrics are provided between the fabric layers, said further and thinner woven fabrics only bearing load when the woven spacer fabric has been compressed to the extent of the thinner woven fabrics. However, such woven fabrics are quite heavy on account of the high fibre content.

DE 195 45 596 C2 discloses an inner lining and/or seat covering material for vehicles, aircraft and the like, in which the foam layer known in the prior art is dispensed with and replaced with a brushed pile cover which is incorporated into a lower fabric. The brushed pile cover is soft-elastic and has a good restoring force, as a result of which it is suitable as a shock-absorbing layer. An upper fabric is then also laminated on. However, such covering materials have a low damping or shock-absorbing effect and cannot replace foams.

GB 1,028,141 A discloses a textile insulation material made of an uncut pile fabric. While the pile fabric is artificially kept at its full spacing, the pile threads thereof are hardened with resin in order that the pile threads keep outer layers of the pile fabric spaced apart.

### SUMMARY OF THE INVENTION

It is therefore the object of the invention to create a cushioning material according to the preamble of Claim 1, the comfort of which is improved.

This object is achieved by the following features.

Cushioning material padding covering of double-pile fabric for resilient, insulating or objects or components, made of a being elastically impregnated by resin impregnation, in which an upper fabric and a lower fabric are connected in a spaced-apart manner by webs that are formed by pile threads, wherein the elastically impregnated double-pile fabric exhibits a shape resilience with a non-linear spring characteristic due to the connecting webs, having a lower characteristic region, a medium characteristic region and an upper characteristic region, the lower and the upper characteristic regions having an ascending profile respectively, while the medium characteristic region has loop profile which gives a less ascending hysteresis the impregnated double-pile fabric an internal damping capacity, and said internal damping capacity is adjusted by the volume weight depending on the used pile threads and/or the degree of hardness of the resin impregnation.

Hereby, a cushioning material is created, the spring characteristic of which is non-linear under formation of a damping zone. Under load, the cushioning material due to the connecting webs of the double-pile fabric initially exhibits a restoring force that increases with the depth of indentation, said restoring force giving the material a flexibility that is known of cushions, pads or upholstery. In this region, the restoring force of the cushioning material is determined by elastic deformation which is provided by the webs connecting the upper fabric and the lower fabric.

Upon increasing load, the characteristic of the cushioning material passes into a medium characteristic region. Preferably, the restoring force is then no longer dependent at all or only slightly dependent on the depth of indentation, since the buckling load of the webs has been reached. These parameters of the cushioning material are directly dependent on the degree of hardness of the resin used and the volume weight of the cushioning material. Both parameters therefore make it possible to adapt the flexibility of the cushioning material to the application in question.

The medium spring characteristic exhibits a pronounced hysteresis behaviour, the cause of which is the resin impregnation, by which the internal friction of the webs on deformation of the webs is increased. This hysteresis behaviour gives the cushioning material in the medium region a damping capacity. In combination with the flatter profile of the characteristic, the cushioning material thus has in this region a particularly good damping effect, since short-time loads or impacts are received quickly and the energy thereof is absorbed by the cushioning material.

Under further increasing loads, the cushioning material exhibits a characteristic with again a larger slope. After extensive deflection of the webs, the restoring force is dominated now by the elastic volume compression of the resin-impregnated double-pile fabric itself. This region determined by the upper characteristic thus prevents excessive sinking into the cushioning material at high loads. If the material is preferably used as upholstery of a vehicle seat, this upper characteristic region provides for the necessary support even in the case of a sporty driving style and, after the end of the increased load, ensures the return to the medium damped characteristic region.

A further advantageous feature of the cushioning material according to the invention is the variable setting of the properties of the material in the medium characteristic region. In particular, the damping capacity is settable by the volume weight and/or the degree of hardness of the of the resin impregnation. The volume weight depends on the pile threads used. Furthermore, the magnitude of the restoring force in the medium characteristic region correlates with the degree of hardness of the resin impregnation and the magnitude of the volume weight.

By varying the settings of the material properties, the cushioning material can be used in a versatile manner, with the parameters of volume weight and resin hardness preferably being selected such that under the loads to be expected for each particular use, the medium characteristic region is reached with a selectable damping capacity. Thus, the cushioning material, when used in mattresses, can be adapted to the weight of the person, while cushioning for the gentle transport of goods should have a high damping capacity.

Further advantages and configurations of the invention can be gathered from the following description and the dependent claims.

The invention is explained in more detail in the following text with reference to the exemplary embodiments illustrated in the appended drawings.

### BRIEF DESCRIPTION OF THE DRAWINGS

FIG. 1 schematically shows the perspective view of a cushioning material according to the invention.

FIG. 2 schematically shows the non-linear spring characteristic of the cushioning material according to the invention, with a medium characteristic region which is characterized by the magnitude of the restoring force and the damping capacity,

FIG. 3 schematically shows the non-linear spring characteristic of the cushioning material according to the invention, with an increased restoring force in the medium characteristic region,

FIG. 4 schematically shows the non-linear spring characteristic of the cushioning material according to the invention, with an increased damping capacity in the medium characteristic region,

FIG. 5 schematically shows the non-linear spring characteristic of the cushioning material according to the invention, with an increased damping capacity in the medium characteristic region.

### DESCRIPTION OF THE SPECIFIC EMBODIMENTS

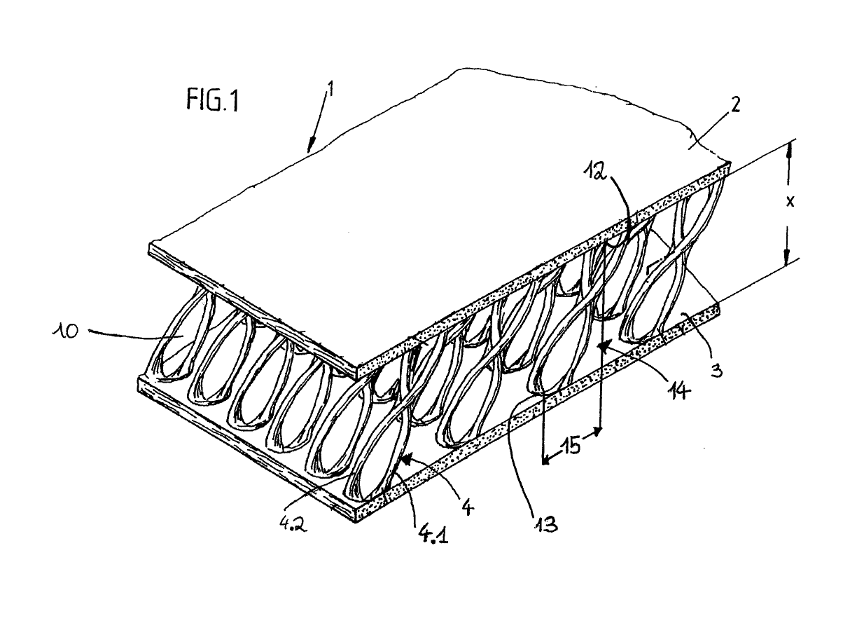

The cushioning material illustrated in FIG. 1 for resilient, insulating or padding covering of objects or components is produced by resin impregnation of a double-pile fabric 1. The resin impregnation is such that the double-pile fabric 1 is elastically impregnated. The double-pile fabric 1 comprises an upper fabric 2 and a lower fabric 3, which are connected to one another in a spaced apart manner by pile threads 4. The pile threads 4 form webs 14, which, in the exemplary embodiment illustrated, consist preferably of helically twisted individual webs 4.1, 4.2 and which space the upper fabric 2 and the lower fabric 3 apart from one another at a spacing X. In this way, a shape resilience with a non-linear spring characteristic 5 is established. With this characteristic the cushioning material shows an elastic deformation and an elastic recovery.

The double-pile fabric 1 provided as per FIG. 1 for resin impregnation is an uncut woven fabric having the upper fabric 2, the lower fabric 3 and incorporated pile threads 4. The connecting pile threads 4 form helically twisted individual webs 4.1, 4.2, which are twisted in the shape of an eight. The individual webs 4.1, 4.2 thus have an intersection region. Furthermore, an axial offset 15 of the two respective ends 12, 13 of the webs 14, which connect the upper fabric 2 and the lower fabric 3 to one another, is technically caused by the weave construction. The axial offset 15 refers to a force that is applied vertically to the upper fabric 2 and/or the lower fabric 3.

The pile threads 4 are formed preferably from a filament yarn, in particular a multi- or monofilament yarn. Under compressive load, the webs 14 have a spring-elastic restoring force on account of inherent stiffness. In conjunction with the formation of the webs 14 as helically twisted individual webs 4.1, 4.2 having an axially offset attachment to the upper fabric 2 and lower fabric 3, pressure loads cause a tangential shear force between the upper fabric 2 and lower fabric 3. The result is an areal spring loading of compressive loads acting on the upper fabric 2 and/or lower fabric 3 by means of the webs 14 with a spring characteristic 5. The spring characteristic 5 of the cushioning material formed in this way is settable via the resin impregnation as well as via the volume weight of the double-pile fabric 1.

The non-linear spring characteristic 5 due to the connecting webs 14 illustrated schematically in FIG. 2 is distinguished by three characteristic regions. The dependence of a restoring force F on the depth of indentation s is depicted. The restoring force F preferably results from a loading force that is applied vertically to the upper fabric 2 and/or the lower fabric 3. A lower characteristic region 7 and an upper characteristic region 8 are formed with an ascending profile. The slope of these characteristic regions can correspond to the spring properties of typical cushioning materials. In comparison, a medium characteristic region 6 extends less ascending and exhibits a hysteresis loop profile, which gives the impregnated double-pile fabric 1 an internal damping capacity W. This damping capacity W is settable by the volume weight (of the cushioning material) depending on the used pile threads 4 and/or the degree of hardness of the resin impregnation.

The magnitude of a restoring force 9 in the medium characteristic region 6 correlates with the degree of hardness of the resin impregnation and the magnitude of the volume weight, with the result that these are setting parameters. Preferably, resins having a degree of hardness in the range of 30 to 90 Shore A are used. The thread size for the thread systems of the upper fabric 2 and the lower fabric 3 and for the thread system of the pile threads 4 is preferably in the range of 60 to 300 tex. The pile threads 4 can be incorporated into the upper fabric 2 and the lower fabric 3 with a V-weave or a W-weave. The density of the pile threads 4 is preferably in the range from 50 to 200 pile threads/cm². The length of the pile threads 4 is preferably in a range from 1.0 to 50 mm. The pile threads 4 preferably consist of a filament yarn. The length of the pile threads 4 thus causes the spacing X. The density and the length of the pile threads 4 in conjunction with the thread size of the thread systems influence, inter alia, the volume weight of the cushioning material.

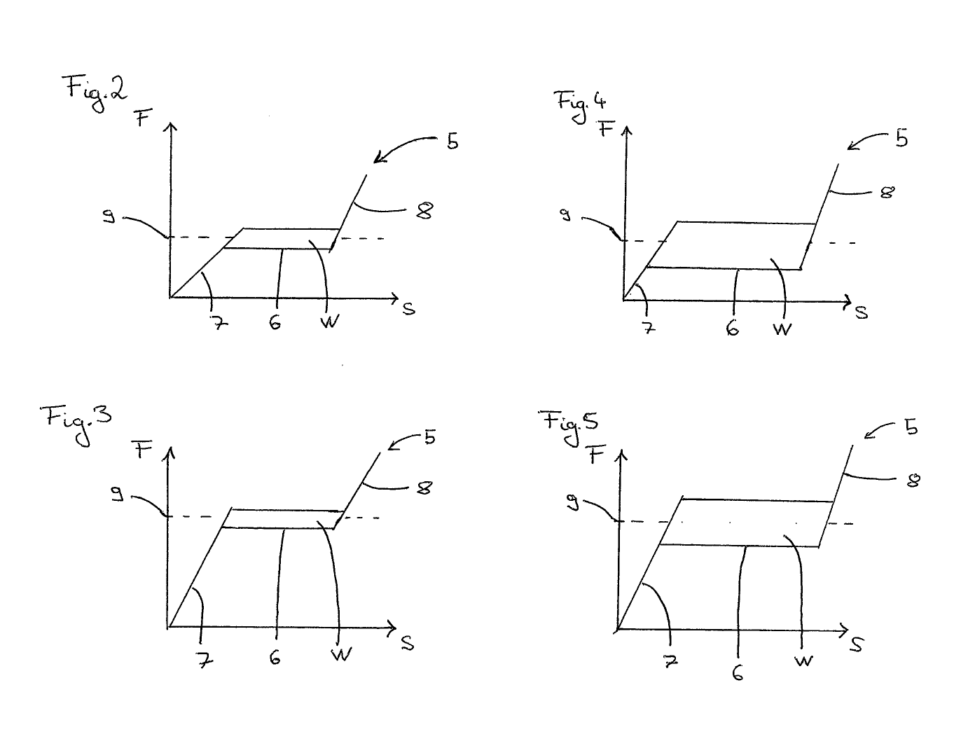

FIG. 3 shows the non-linear characteristic 5 of an exemplary embodiment in which, by selection of a high volume weight, for example a thread size of 300 tex for one or more thread systems of the double-pile fabric 1 and a length of the pile threads 4 of about 15 mm, the restoring force 9 of the medium characteristic region 6 with a corresponding damping capacity W is increased.

FIG. 4 illustrates an exemplary embodiment in which the damping capacity W is increased by the selection of a harder resin, of for example 80 Shore A.

The exemplary embodiment illustrated in FIG. 5 shows a cushioning material having an increased restoring force 9 and an increased damping capacity W. This can be achieved by the selection of a harder resin, of for example 80 Shore A, in conjunction with a high volume weight, for example a thread size of 300 tex for one or more thread systems of the double-pile fabric 1 and a length of the pile threads 4 of about 15 mm.

Since the use of a harder resin also increases the restoring force 9 and stiffens the cushioning material overall, the variation in the volume weight for harder resins than for example 60 Shore A only has a smaller effect.

According to an exemplary embodiment that is not illustrated, the cushioning material may be connected to a ventilation or heating system. Since, according to the invention, only the pile threads 4 are arranged between the upper fabric 2 and the lower fabric 3, a free space 10, through which a fluid flow can be passed, is formed between the upper fabric 2 and the lower fabric 3. The cushioning material according to the invention thus affords improved sitting comfort in combination with an air-conditioning effect, without additional components being made necessary for this purpose. The medium which to this end is passed through the free space 10 is selectable and can be any form of fluid.

As the above exemplary embodiments show, the setting parameters of resin hardness and volume weight allow the formation of a cushioning material also in such a way that comparable cushioning properties are achieved even for different cushioning material weights. The setting parameters can partially substitute one another.

The upper fabric 2 and the lower fabric 3 can be woven, loop-drawingly knitted, loop-formingly knitted, or be in the form of raschel fabric. The double-pile fabric 1 can be produced by the warp velvet technique. Resins that are used for resin impregnation are for example PU resins. The filament yarns consist preferably of aramid fibre, carbon fibre, ceramic fibre and/or glass fibre or a mixture of these fibres.

The double-pile fabric 1 can also be foam-filled in the free space 10 between the pile threads 4 with an in particular soft foam material, as a result of which the damping capacity W can additionally be influenced, in particular in the medium characteristic region 6. Such a foam can also be used to carry substances which can be dispensed by the cushioning material during its use. The sitting movement becomes a pumping movement which can deliver substances out of such a foam material. This is advantageous in particular in the case of antimicrobial additives or other disinfectants with which the foam may be provided.

1. Cushioning material for resilient, insulating or padding covering of objects or components, made of a double-pile fabric being elastically impregnated by resin impregnation, in which an upper fabric and a lower fabric are connected in a spaced-apart manner by webs that are formed by pile threads, wherein the elastically impregnated double-pile fabric exhibits a shape resilience with a non-linear spring characteristic due to the connecting webs, having a lower characteristic region, a medium characteristic region and an upper characteristic region, the lower and the upper characteristic regions having an ascending profile respectively, while the medium characteristic region has a less ascending hysteresis loop profile which gives the impregnated double-pile fabric an internal damping capacity, and said internal damping capacity is adjusted by the volume weight depending on the used pile threads and/or the degree of hardness of the resin impregnation.

2. Cushioning material according to claim 1, wherein the magnitude of the restoring force in the medium characteristic region correlates with the degree of hardness of the resin impregnation and the magnitude of the volume weight.

3. Cushioning material according to claim 1, wherein the degree of hardness of the resin impregnation is settable in a range from 30 to 90 Shore A.

4. Cushioning material according to claim 1, wherein the double-pile fabric comprises yarns with a thread size in the range from 60 to 300 tex.

5. Cushioning material according to claim 1, wherein the webs formed by the pile threads consist of helically twisted individual webs being axially loadable spring elements.

6. Cushioning material according to claim 5, wherein the two respective ends of the webs are attached to the upper fabric and the lower fabric with an axial offset.

7. Cushioning material according to claim 1, wherein the webs formed by the pile threads define a spacing in the range of 5 to 20 mm.

8. Cushioning material according to claim 1, wherein the upper fabric and lower fabric are woven fabrics or knitted fabrics.

9. Cushioning material according to claim 1, wherein the double-pile fabric is connectable to a ventilation or heating system.

10. Cushioning material according to claim 1, wherein the double-pile fabric is filled with a foam in a free space between the pile threads.

11. Cushioning material according to claim 10, wherein the foam is a soft foam including antimicrobial additives.
